(19) United States
(12) Patent Application Publication
(10) Pub. No.: US 2022/0148177 A1
(43) Pub. Date: May 12, 2022

(54) FAST STAINING OF BIOMATERIALS ENHANCED BY IMAGE PROCESSING AND ARTIFICIAL INTELLIGENCE

(71) Applicant: Essenlix Corporation, Monmouth Junction, NJ (US)

(72) Inventors: Wu Chou, Basking Ridge, NJ (US); Hongbing Li, Skillman, NJ (US); Susan Y. Sun, Basking Ridge, NJ (US); Xing Li, Metuchen, NJ (US); Wei Ding, Princeton, NJ (US); Stephen Y. Chou, Princeton, NJ (US)

(73) Assignee: Essenlix Corporation, Monmouth Junction, NJ (US)

(21) Appl. No.: 17/616,178

(22) PCT Filed: Jun. 2, 2020
(86) PCT No.: PCT/US20/35783

§ 371 Date: Dec. 2, 2021

Related U.S. Application Data
(60) Provisional application No. 62/856,140, filed on Jun. 2, 2019.

(51) Int. Cl. G06T 7/00; G01N 1/31; G01N 1/28; G01N 21/64

(52) U.S. Cl. CPC G06T 7/0012; G01N 1/312; G01N 1/2813; G01N 21/6428; G01N 2001/302; G06T 2207/10056; G06T 2207/20081; G06T 2207/30024; G06T 2207/10024

(57) ABSTRACT

Among other things, the present invention provides devices and methods that stain a sample simply (e.g. one step) and quickly (e.g. <60 seconds), image it without wash, and generate, by a machine learning algorithm, a final image similar to a standard staining with wash.

### CROSS REFERENCING

This application is a National Stage Entry (§ 371) of International Application No. PCT/US2020/035783, filed on Jun. 2, 2020, which claims the benefit of U.S. Provisional Application No. 62/856,140, filed on Jun. 2, 2019, both of which are incorporated herein in their entirety for all purposes.

### FIELD

Among other things, the present disclosure is related to devices and methods of performing cell and/or tissue staining and imaging.

### BACKGROUND

In biological and chemical assays (e.g. diagnostic testing), often it needs to stain visualize and analyze biological samples quickly, simply, and low cost. The present invention provides devices and methods for achieving these goals. In particular, among other things, the present invention provides devices and methods that stain a sample simply (e.g. one step) and quickly (e.g. <60 seconds), image it without wash, and generate, by a machine learning algorithm, a final image similar to a standard staining with wash.

### SUMMARY OF THE INVENTION

One aspect of the present invention is to perform rapid pathology and cytology without washing. Particularly, the present invention is related to devices and methods that stain a sample ready for imaging simply and quickly without washing and with a short incubation time (less than a few minutes, or 60 seconds or less).

Another aspect of the present invention is to generate, using a machine learning algorithm, a target image from an image taken from a stained sample without wash, wherein the target image has a similar quality as if the stained sample is washed.

Another aspect of the present invention is that the machine learning algorithm is trained using a training data set that comprises at least one image of the stained sample without a wash and at least one image of the stained sample with a wash.

Another aspect of the present invention is a kit for staining a sample without wash, comprising: (a) a first plate and a second plate that face each other and are separated by a spacing; and (b) a staining reagent of a concentration that stains the sample for analysis; wherein the spacing and the concentration are selected such that when the sample and the staining reagent are sandwiched between the first plate and the second plate and are imaged without wash, a staining of the sample is visible.

Another aspect of the present invention is that the spacing between the two plates is selected such that the staining reagent can diffuse on the sample quickly and the staining reaches a saturation fast, (for example 30 seconds or less or 60 seconds or less).

The present invention is not virtual staining, but rather image enhancements that generate high quality stained images, through machine learning, from the images stained at a low concentration of reagents or stained with a much shorter staining time, in which the image has a very low contrast, and high noise level or both.

In some embodiments, a method of staining and imaging a sample without wash, comprising:
(a) providing a first plate and a second plate;
(b) sandwich the sample and a staining reagent between the first plate and the second plate, wherein the staining reagent stains the sample;
(c) capturing a first image of the stained sample without a wash, wherein the wash removes at least a part of the staining reagent; and
(d) generating a target image of the stained sample from the first image using an a machine learning algorithm;

wherein the machine learning algorithm is trained using a training data set that comprises at least one image of the stained sample without a wash and at least one image of the stained sample with a wash.

In some embodiments, a kit for staining a sample without wash, comprising:
(a) a first plate and a second plate that face each other and are separated by a spacing;
(b) a staining reagent of a concentration that stains the sample for analysis;

wherein the spacing and the concentration are selected such that when the sample and the staining reagent are sandwiched between the first plate and the second plate and are imaged without wash, a staining of the sample is visible. In some embodiments, a system for staining and imaging a sample, comprising:
(a) the kit of prior embodiments;
(b) an imager for capturing the image of the stained sample between the first and the second plate;
(c) a non-transitory storage media storing a machine learning algorithm that generates a target image from the image of the stained sample.

wherein the machine learning algorithm is trained using a training data set that comprises at least one image of the stained sample without a wash and at least one image of the stained sample with a wash.

In some embodiments, a method of staining and imaging a sample, comprising:
(a) providing a first plate and a second plate, wherein one or both of the two plates comprise at least three position markers, wherein each pair of the at least three position markers has a predetermined distance between them;
(b) sandwiching the sample and a staining reagent between the first plate and the second plate, wherein the staining reagent stains the sample;
(c) capturing a first image of the stained sample and the at least three position markers; and
(d) generating a target image of the stained sample from the first image using a machine learning algorithm;

wherein the machine learning algorithm is trained using a training data set that comprises at least one image of the at least three position markers and the stained sample that is stained in a first set of conditions, and at least one image of the stained sample that is stained in a second set of conditions.

In some embodiments, a kit for staining a sample, comprising:
(a) a first plate and a second plate that face each other and are separated by a spacing, wherein one or both of the plates comprise at least three position, wherein each pair of the at least three position markers has a predetermined distance between them; and
(b) a staining reagent of a concentration that stains the sample for analysis;

wherein the spacing and the concentration are selected such that when the sample and the staining reagent are sandwiched between the first plate and the second plate and are imaged without wash, a staining of the sample is visible.

In some embodiments, a system for staining and imaging a sample, comprising:
(a) the kit of prior embodiment;
(b) an imager for capturing the image of the stained sample between the first and the second plate;
(c) a non-transitory storage media storing a machine learning algorithm that generates a target image from the image of the stained sample.
(d) wherein the machine learning algorithm is trained using a training data set that comprises at least one image of the at least three position markers and the stained sample that is stained in a first set of conditions, and at least one image of the stained sample that is stained in a second set of conditions.

The device, kit, systems and method of any prior embodiments further comprising the spacers that regulate the distance between the first plate and the second plate.

In some embodiments, the spacing between the two plate or the height of the spacer is selected between 0.5 um to 30 um.

In some embodiments, the spacing between the two plate or the height of the spacer is 10 um.
In some embodiments, the two plates are movable relative to each other.
In some embodiments, the spacing between the two plates or the spacer height is selected to have a stain saturation time of 5 sec, 10 sec, 20 sec, 30 sec, 60 sec, or a range between any two of the values.

In some embodiments, further comprising the spacers that regulate the distance between the first plate and the second plate.

In some embodiments, the sample is a tissue.

In some embodiments, the machine learning algorithm employs CycleGAN.

In some embodiments, the machine learning algorithm employs GAN based pixel-to-pixel transform.

In some embodiments, the machine learning algorithm is trained using a training data set that comprises at least one image of the at least three position markers and the stained sample that is stained in a first set of conditions, and at least one image of the stained sample that is stained in a second set of conditions.

In some embodiments, the machine learning algorithm employs at least four position markers are at least.

In some embodiments, the machine learning algorithm employs the position markers that have a geometry and/or a inter distance between the position markers in x-direction different from that in y-direction which is orthogonal to the x-direction.

In some embodiments, the sample comprises bodily fluid selected from the group consisting of amniotic fluid, aqueous humour, vitreous humour, blood, breast milk, cerebrospinal fluid (CSF), cerumen (earwax), chyle, chime, endolymph, perilymph, feces, breath, gastric acid, gastric juice, lymph, mucus, pericardial fluid, peritoneal fluid, pleural fluid, pus, rheum, saliva, exhaled breath condensates, sebum, semen, sputum, sweat, synovial fluid, tears, vomit, urine, and any combination thereof.

In some embodiments, the staining is H&E staining, immunohistochemical staining, immuno-fluorescence staining, and in situ hybridization staining, or any combination of thereof.

In some embodiments, the staining reagent is a dry staining reagent coated on the surface of at least one of the plates.

The device, kit, and method of any prior embodiments, wherein the staining reagent is a dry staining reagent coated on the surface of at least one of the plates, and wherein the staining solution is a transfer liquid that transfer the dry stain agent into the sample.

In some embodiments, the spacers are position markers.

In some embodiments, the inter distance between neighboring spacers or between neighboring position markers is in the range of 50 μm to 120 μm.

In some embodiments, the fourth power of the inter-spacer-distance (ISD) divided by the thickness of the flexible plate (h) and the Young's modulus (E) of the flexible plate, ISD⁴/(hE), is equal to or less than 10⁶ um³/GPa.

In some embodiments, the spacer height is selected in the range of 1.8 to 50 μm, the IDS is 100 um or less, the fourth power of the inter-spacer-distance (IDS) divided by the thickness (h) and the Young's modulus (E) of the flexible plate (ISD\hat{ }4/(hE)) is 5×10\hat{ }5 um\hat{ }3/GPa or less; the thickness of the flexible plate times the Young's modulus of the flexible plate is in the range of 60 to 750 GPa-um.

In some embodiments, the spacing between the two plate is regulated by spacers. In some embodiments, the two plates are movable relative to each other into different configurations, including an open configuraiotn and a closed configuration.

### BRIEF DESCRIPTION OF THE DRAWINGS

A skilled artisan will understand that the drawings, described below, are for illustration purposes only. The drawings are not intended to limit the scope of the present teachings in any way. The drawings are not entirely in scale. In the figures that present experimental data points, the lines that connect the data points are for guiding a viewing of the data only and have no other means.

FIG. 1. One embedment for achieve, using machine learning, a high quality image from the image of the samples prepared by fast staining at a low stain reagent concentration without washing.

FIG. 2. One embedment for fast staining without washing (the spacer is optional)

FIG. 3. A diagram for generating the training data set for machine learning algorithm for 1 min H&E staining without wash. A first set of images of a tissue that is stained in low staining concentration between two plates with a small spacing for a short time (e.g. 60 seconds). Then the second plate is removed and the same tissue is stained again but using a standard staining procedure with wash. A second set of image is taken after the standard staining.

FIG. 4. An illustration for training a machine learning algorithm for a high Resolution machine learning based predicative staining.

FIG. 5. An illustration for use a machine learning algorithm for a high Resolution meachine learning based predicative staining.

### DETAILED DESCRIPTION OF EXEMPLARY EMBODIMENTS

The following detailed description illustrates some embodiments of the invention by way of example and not by way of limitation. The section headings and any subtitles used herein are for organizational purposes only and are not to be construed as limiting the subject matter described in any way. The contents under a section heading and/or subtitle are not limited to the section heading and/or subtitle, but apply to the entire description of the present disclosure.

The citation of any publication is for its disclosure prior to the filing date and should not be construed as an admission that the present claims are not entitled to antedate such publication by virtue of prior invention. Further, the dates of publication provided can be different from the actual publication dates which can need to be independently confirmed.

The term “present disclosure” and “present invention” are interchangeable.

The term “FAST” (all in capital letters) means the “fast staining” of the present invention, which includes, not limited to, all fast staining devices and/or methods described by the present invention.

The terms “perform, using a Q-Card, an assay (including staining in pathology) without using a wash” and “perform, using a Q-Card, an assay (including staining in pathology) wash-free” are interchangeable.

The term “wash” refers to use a solution to remove at least a part of the staining reagent that is used for staining a sample.

The terms “in a closed configuration” and “at a closed configuration” for the plates of the Q-Card are interchangeable.

The terms “analyte” and “biomarker” are interchangeable.

The term “sample” includes, but not limited to, biomaterials,

Fast Staining Without Washing Using Two Plates and Machine Learning

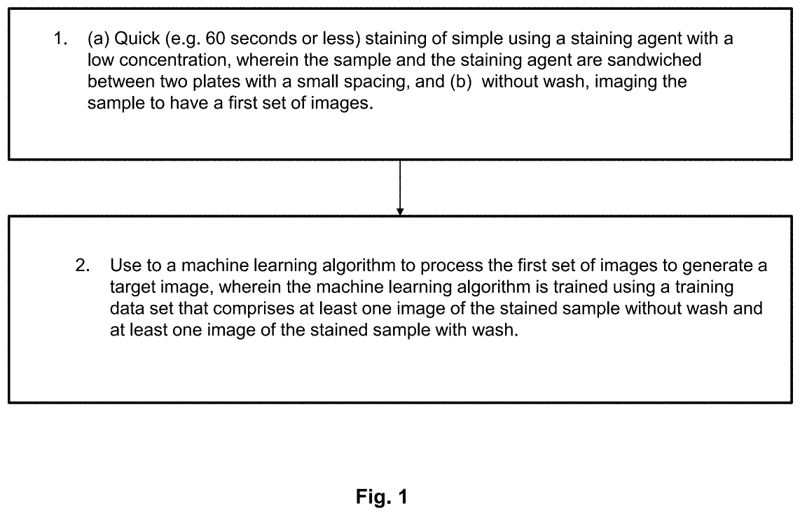

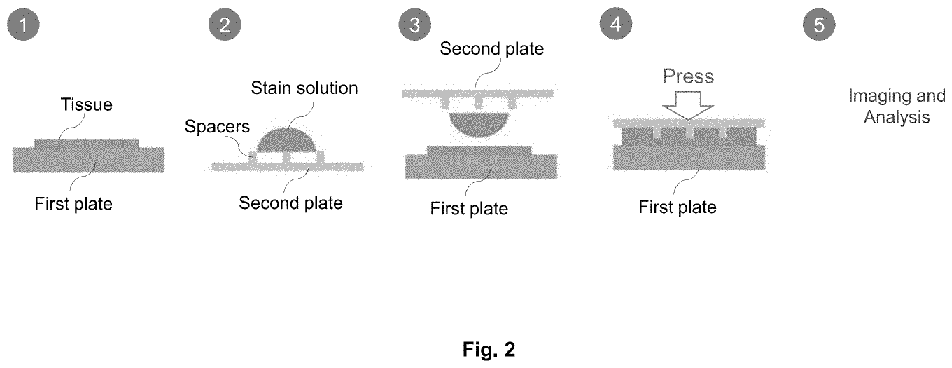

In today's pathology and cytology, staining a sample often requires multiple steps and at least a washing step, before the sample is imaged for analysis. According to one aspect of the present invention, as shown in FIGS. 1 and 2, (i) a sample and a staining reagent (or a staining solution that contains a staining reagent) will be placed between two plates, then the sample is imaged for an analysis without washing away the staining reagent; and (ii) Use to a machine learning algorithm to process the first set of images to generate a target image, wherein the machine learning algorithm is trained using a training data set that comprises at least one image of the stained sample without wash and at least one image of the stained sample with wash.

In the first step of staining without wash, the spacing between the two plates (hence the thin sample and staining reagent layer) and the concentration of the staining reagent are selected such that when the sample and the staining reagent are sandwiched between the first plate and the second plate and are imaged without wash, a staining of the sample is visible.

In some embodiments, the staining reagent concentration and the shorter staining time are configured for fast staining and imaging without wash, wherein the image does not have a high contrast as that in a normal multistep staining with wash, but a machine learning algorithm is applied to construct the final image from the low contrast images of low staining concentration, shorter staining time, and unwashed sample.

The present invention is not virtual staining, but rather image enhancements that generate high quality stained images, through machine learning, from the images stained at a low concentration of reagents or stained with a much shorter staining time, in which the image has a very low contrast, and high noise level or both.

### A Small Spacing between Two Plates for Reducing Incubation Time and Background Noise

According to the present invention, a small spacing between the two plates is used for several reasons.

(1) A small spacing between the two plates makes the staining solution thickness thin, which reduces the diffusion distance for a stain agent in the stain solution to across the thickness to reach the sample, hence reducing the diffusion time and a saturation staining time. This leads to a short incubation time. This also can save the stain agent usage reducing cost.

(2) A small spacing between the two plates also reduce the background noise in imaging generated by the unconsumed stain agent in the stain solution. We found experimentally that for a given sample and a concentration of a stain solution, the smaller spacing between the two plates (i.e. the thinner the thin layer thickness), the less the background noise in imaging, and the clearer the image of the stained sample.

Concentration of Stain agent in the Stain Solution and the Spacing.

According to the present invention, the concentration of the stain agent in the stain solution is selected, such that, for a given small spacing between the two plates (that makes thin sample and stain solution layer thickness) and at the end of an incubation, most of the stain agent in the stain solution is consumed for staining the target tissue or cell, having little left in the stain solution. This can greatly reduce background noise in imaging and can save the cost on stain agent. This also can avoid overstaining a sample.

The total staining reagent received by a sample depends on both the spacing between the two plates and the staining reagent concentration. In some embodiments, the spacing and the concentration are selected such that when the sample and the staining reagent are sandwiched between the first plate and the second plate and are imaged without wash, a staining of the sample is visible.

In some embodiments, to make the staining of a sample visible without washing when using the selected spacing and the concentration, the sample is lightly stained and low contract. According to the present invention, a machine learning algorithm is used to generate, from the low contrast image of light stained and without wash, a high contrast image similar to a sample that is well stained and washed.

According to the present invention, in some embodiments of assaying (including staining) using a Q-Card, the spacing between the two plates is configured to make the assay having a stain saturation time is 5 sec, 10 sec, 20 sec, 30 sec, 60 sec, 90 sec, 120 sec, 180 sec, 300 sec, 600 sec, or a range between any two of the values. In some embodiments, the spacing between the two plates is 0.5 um, 1 um, 2 um, 5 um, 10 um, 20 um, 30 um, 40 um, 50 um, or a range between any two of the values. In some embodiments, the spacing between the two plates are regulated by the height of the spacers between the two plates. The spacers have a height of 0.5 um, 1 um, 2 um, 5 um, 10 um, 20 um, 30 um, 40 um, 50 um, or a range between any two of the values.

In some preferred embodiments, a stain saturation time is 5 sec, 10 sec, 20 sec, 30 sec, 60 sec, or a range between any two of the values. In some preferred embodiments, the spacing between the two plates is 0.5 um, 1 um, 2 um, 5 um, 10 um, 20 um, or a range between any two of the values. In some embodiments, the spacing between the two plates is 10 um. In some preferred embodiments, the spacers have a height of 0.5 um, 1 um, 2 um, 5 um, 10 um, 20 um, or a range between any two of the values. In some embodiments, the spacer is 10 um height.

An Example of Training Machine Learning Algorithm for Imaging a Sample with a Fast Stain without Wash

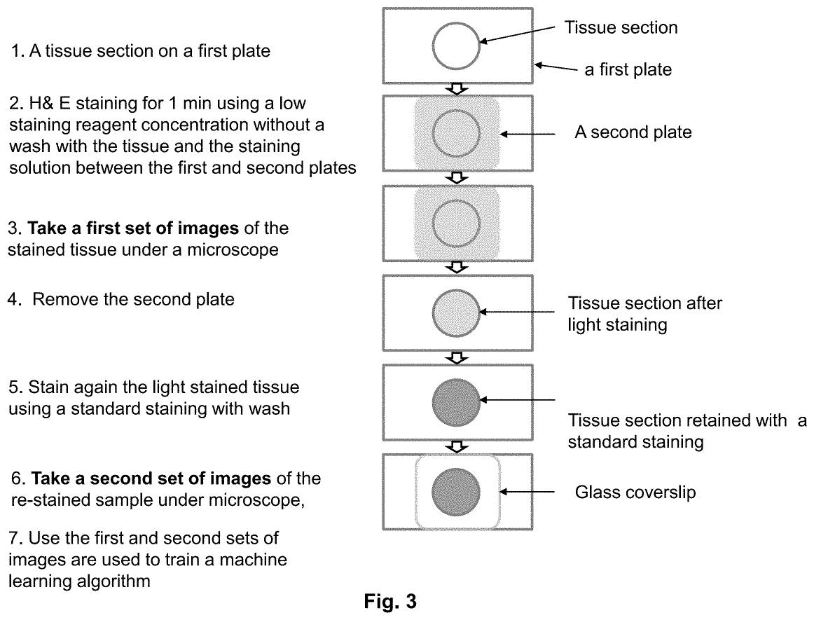

FIG. 3 illustrates an embodiment for generating the training data set for machine learning algorithm for imaging 1 min H&E staining without wash. The training comprises: 1. Placing a tissue section on a first plate; 2. sandwiching the tissue and the staining solution (H& E staining reagent) between the first and second plates and staining for 1 min using a low staining reagent concentration without a wash; 3. taking a first set of images of the stained tissue under a microscope; 4. removing the second plate; 5. staining again the light stained tissue using a standard staining with wash; 6. taking a second set of images of the re-stained sample under microscope; 7. using the first and second sets of images are used to train a machine learning algorithm.

### Another Example of Training a Machine Learning algorithm for Fast Staining of Biomaterials

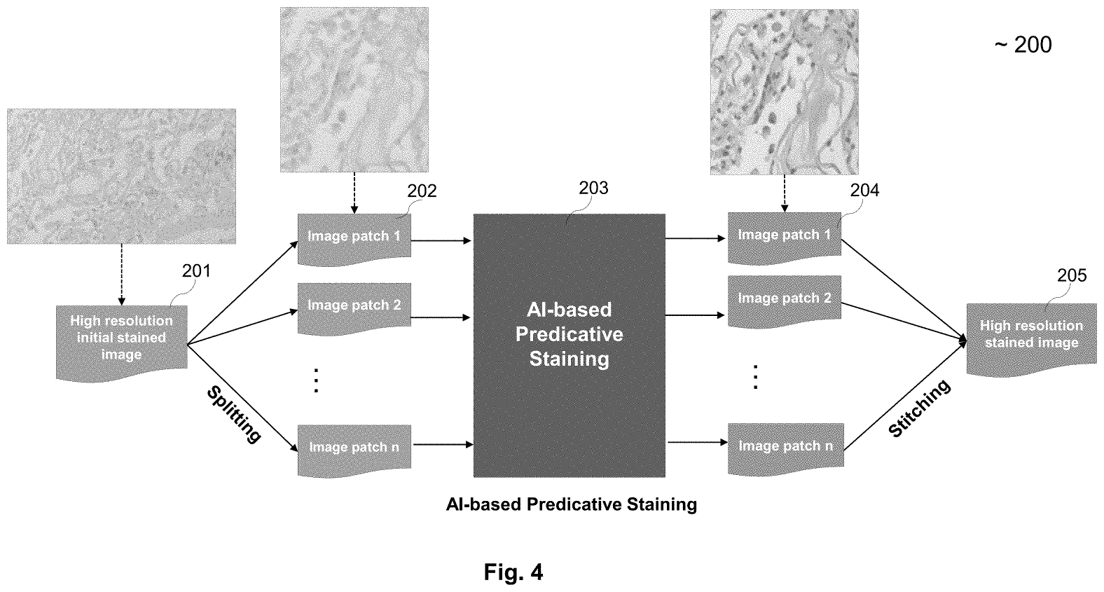

FIG. 4 shows a block diagram of process 300 for training high resolution machine learning-based predicative staining model in the present invention. In various implementations of the process 300, some actions may be removed, combined, or broken up into sub-actions. The training process begins at the action module 303 that prepares fast stained and unwashed images for transformation model building. In some embodiments, the action module 303 comprises the following (training data preparation for domain A—the images of fast stained and unwashed sample, and domain B—the images of well stained washed sample):
a. placing the biomaterials on the sample holding Q-card, wherein the staining reagent is added to the biomaterials in one or a combination of the following ways:
   i. printing the staining reagent on to the second plate of the Q-card as depicted in FIG. 2, and dosing the second plate to make the biomaterials in contact with the staining reagent as illustrated in FIG. 2;
   ii, adding the staining reagent to the biomaterials on the sample holding Q-card directly on the first plate in FIG. 2, when the card is open, and then dosing the card as depicted of FIG. 2 to make staining reagent in contact with the biomaterials; and/or
   iii. printing a staining reagent on the second plate, providing a transfer medium between the second plate and the sample, and sandwiching the transfer medium and the second between the first plate and the second plate, wherein the staining reagent can dissolved in the transfer medium and diffused into the sample,
b. taking the image of the biomaterials in the sample holding Q-card that is closed (i.e. the sample and the staining reagent are sandwiched between the first plate and the second plate), as depicted in FIG. 2, at the fast staining time interval, such as 60 seconds in some embodiments, and taking images for the training database DB1;
c. opening the second plate while keeping the biomaterials on the first plate as shown in Hg. 2, adding more staining reagent to the biomaterial on the Q-card and incubate; performing wash to remove the stain reagent that are not used in staining the biomaterials; and, taking the image of the stained biomaterial in the Q-card in closed configuration, and saving them into the training database DB2.

Thus, constructed image database DB1 comprises of the images from domain A—the fast stained but not washed biomaterial images, and DB2 comprises images from domain B—the images of well stained and washed biomaterial. Then the DB1 and DB2 are used to train the machine learning algorithm.

In some embodiments, the images in DB1 and DB2 come from the same biological sample. In some embodiments, the images in DB1 and DB2 come from the same biological sample and the same area of the sample. In some embodiments, the images in DB1 and DB2 come from different biological samples, and do not form matching pairs. In the present invention, images in DB1 and DB2 are further segmented into image patches according to the pillars on the plate in FIG. 2. And the machine learning model (i.e. algorithm) training is to build a transformation model that transforms the fast stained but unwashed biomaterial image to its well-washed and stained counter parts taking the images from DB2 as guidance. In some embodiments, the training through image segmentation comprises the following actions:
a. taking images from DB1, splitting each image into patches according to the pillars of the Q-card in the image, wherein each image patch had four corners defined by the four pillars on the second plate (also termed “x-plate”) wherein the distance between each pair of the pillars are predetermined (i.e, known) during the card (i.e. the pate)fabrication, and save the patches cut from each image in DB-A (in some embodiments, at least three pillars (termed “position marks”) with a predetermined distance between each pair of the pillars are used);
b. taking images from DB2, splitting each image into patches according to the pillars of the Q-card in the image, wherein each image patch had four corners corresponding to four pillars of the Q-card that have a known contour from the card fabrication, and save the patches cut from each image in DB-B; and
c, taking image patches from DB-A as input A, depicted as component 303 in FIG. 4, and image patches from DB-B as input_B, depicted as component 312 in FIG. 4;
d. performing the cyclic machine learning training that transforms the images in DB-A of fast staining but no washed sample image patches to the domain of well washed staining sample image counterparts exemplified by the well washed sample image patches in DB-B, and transforms images in DB-B to the domain of fast stained but not washed sample images exemplified by images of DB-A with cycle consistency and the additional constrain that the known edge contour of the image patches are aligned.

In some embodiments, the use of cyclic machine learning, such as CycIeGAN, is to bypass the requirement of perfect aliened matching image pairs from two different image domains, which can be hard to obtain. Cyclic machine learning, such as CycleGAN, is based on the framework of cyclic transformation F: domain A to domain B and G: domain B to domain A with cycle consistency constraint such that G(F(x))˜x and F(G(y))˜y where x ∈ domain A and y ∈ domain B.

Cycle consistency, such as those used in CycleGAN machine learning, makes many applications possible, but it needs to be enhanced for high transform fidelity. The use of

Q-card pillar structure to split the image into patches in the present invention adds additional structural constraint to the image transformation. As such, even the image patches are not paired, the images can be matched using their four corners defined by the four pillars on the second plate wherein the distance between each pair of the pillars are predetermined (i.e, known) during the card (i.e. the pate) fabrication (in many cases, the match has a high precision, due to a high precision of the pillars fabrication, e.g. using high precision fabrication process of nano-imprint). This unique structural constraint in the present invention enhances the cycle consistency in the image transformation and improves the fidelity in the transformed images.

In some embodiments, a perfectly aligned matching pairs from two domains are available, the training uses the matching pair based image-to-image transformation to transform the fast stained but unwashed sample image to its final stained and washed sample images for assaying.

### Another Example of Use Machine Learning for Fast Staining of Biomaterials

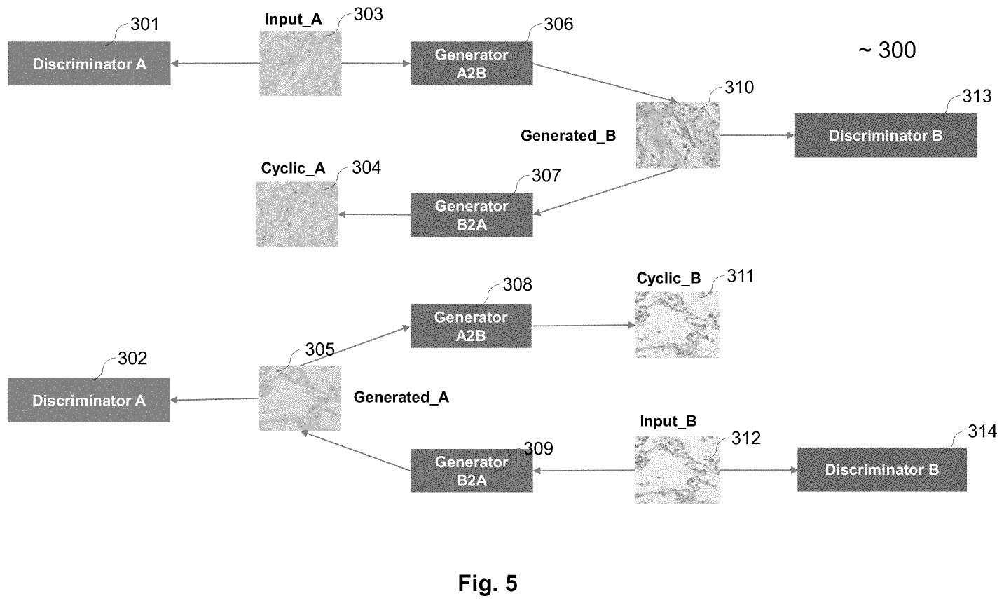

FIG. 5 shows a block diagram of process 200 that performs the machine learning based predicative staining for fast staining without wash sample using a trained machine learning algorithm, such as discussed in FIG. 4. The machine learning based predicative staining comprises:
a. taking a first image of the biomaterials in the sample holding Q-card, depicted in FIG. 2 and incubating the sample for a short staining time interval, e.g. 60 seconds;
b. splitting the first image into patches according to the structures of pillars of the sample holding Q-card (e.g. on the second plate) with its four corners corresponding to the four pillars in the Q-card as illustrated in action modules 201 and 203 of FIG. 5;
c. performing the machine learning-based predicative staining based on the model from process 300 of FIG. 5—the fast staining machine learning model (i.e. algorithm) to transform each image patch from the fast stained but not washed sample image to a new image which is similar to a well stained and washed high resolution counterpart image patch as illustrated by the action module 203 of FIG. 5; and
d. sticking the transformed image patches into the final fast washed image for assaying as depicted in action module 204 and 205 of FIG. 5.

In some embodiments, the fast stained images collected in training is taken from multiple time instants corresponding to the fast staining image taken instants, e.g. 30 seconds, 60 seconds, 90 seconds, 120 seconds, etc. In some embodiments, one machine learning model transforms the fast staining image taken at multiple time instants to one well stained and washed high resolution image. In some embodiments, separate machine learning models are built for each selected time instant to transform the fast and lightly stained image on that instant to one well stained and washed high resolution counterpart image.

In some embodiment, an additional structural constraint of orientation is added in the image transformation for fast staining, wherein the pillars are fabricated in the shape of rectangles with their longer edge parallel to the y-axis and their shorter edge parallel to the x-axis. As such, both pillars and the pillar surrounded image patches have orientations that can further enhance the structural constraint in the image transformation for high fidelity. In some embodiments, the period of the pillars in x-direction is different from that in y-direction.

In some embodiments, the training image patch database DB-A from fast staining is oriented along the original orientation of the image. This is achieved by detecting the orientation of the pillar surrounded image patch from the pillar orientation of its four corners, and rotating the image patch if needed to make the image patch vertical, i.e. the long edges of the four Conner pillars are parallel to the y-axis. Same is performed on the training image patches in database DB-B obtained from well washed and stained images. The orientation specified image data in DB-A and DB-B are used in the machine learning model training process 300 as depicted in FIG. 4. In fast staining, the image is split into pillar surrounded patches, keeping the original orientation that the long edge of their corner pillars are parallel to the y-axis, and process 200 of FIG. 5 is performed to transform the fast stained but no wash biomaterials to its well washed and stained counterpart for assaying.

### Another Example of Training Machine Learning Algorithm for Imaging a Sample with a Fast Stain (H&E Staining) without Wash

Paraffin embedded tissue sections (Zyagen, CA), 10 um pillar height PMMA film,

Hematoxylin & Eosin stain kit (Vector lab, CA).

Experimental procedure:
1. Deparaffinize tissue sections using 2 times of Histoclear, and hydrate sections from 100% ethanol to distilled water.
2. Light staining and imaging for 1^{st} set of images:
   a. Mix 5 ul of hematoxylin solution and 5 ul of eosin solution from Hematoxylin & Eosin stain kit (Vector lab) in eppendorf tube;
   b. Drop 10 ul of H&E staining solution onto tissue section, and cover with a 10 um pillar height PMMA film, incubate at room temperature for 1 min;
   c. Image tissue section under microscope.
3. After imaging, gently remove 10 um pillar height PMMA film, wash slide with distilled water, continue the same tissue section for standard H&E staining and imaging.
4. Standard H&E staining and imaging for 2^{nd} set of images:
   a. Apply adequate Hematoxylin to completely cover tissue section and incubate for 5 minutes.
   b. Rinse slide in 2 changes of distilled water (15 seconds each) to remove excess stain.
   c. Apply adequate Bluing Reagent to completely cover tissue section and incubate for 10-15 seconds.
   d. Rinse for slide in 2 changes of distilled water (15 seconds each).
   e. Dip slide in 100% ethanol (10 seconds) and blot excess off.
   f. Apply adequate Eosin Y Solution to completely cover tissue section and incubate for 2-3 minutes.
   g. Rinse slide using 100% ethanol (10 seconds).
   h. Dehydrate slide in 3 changes of 100% ethanol (1-2 minutes each).
   i. Histoclear and coverslip.
   j. Take 2^{nd} set of images of standard stained tissue section under microscope.
5. Training a machine learning algorithm using the two sets of images.

In some embodiments, the imaging is a process that takes a multiple images sequentially. In the analysis, the multiple images will be analyzed and processed, and then will be used to construct the final image of the staining according to certain algorithm (including signal process and machine learning).

In some embodiments, the time interval between two sequential images is 1 second or less, 10 second or less, 30 second or less, 60 second or less, 90 second or less, 120 second or less, 150 second or less, 240 second or less, 300 second or less, or an interval between any of two.

In some embodiments, the reconstruction algorithm uses machine learning algorithms, which trains the reconstruction according to a known final result.

In some embodiments, the reconstruction algorithm uses signal processing which select features of each images for the reconstruction, wherein the signal processing algorithm is determined from examples of a known final result.

In some embodiments, the concentration of the staining reagent is greatly reduced compared to normal multiple staining.

In some embodiments of the present invention, it comprises further a step of determining a diseases and/or disorder of a subject.

In some embodiments of the present invention, it comprises the following features, which can be used alone or in any combination:

1. The two plates are the two plates in QMAX card, wherein the Q-MAX cards are disclosed in the rest of the present invention specification.

2. The volume A and B, each volume has, during the imaging step, one surface of the volume in contact with the one of the two plates and another surface of the volume in contact with other plate.

3. The probe comprises a probe that binds specifically to the analyte.

4. Before the imaging step, the method further comprises a step of permeabilizing the cell.

5. In some embodiments, the cell permeabilizing is performed by coating a dry permeabilizing agent on one of the plates.

6. In above steps (sandwiching the sample and the probe), the prob comprises a staining liquid forming the probe, wherein the staining solution and the sample are sandwiched between the two plates.

7. In the sample region being imaged, the spacing between the two plates (i.e. that is a distance between the inner surface of the two plates, wherein an inner surface is the surface facing the sample) is 0.5 um, 1 um, 2 um, 3 um, 5 um, 10 um, 15 um, 20 um, 30 um, 50 um, or a range between any two of the values.

In some preferred embodiments, the spacing between the two plates (i.e. that is a distance between the inner surface of the two plates, wherein an inner surface is the surface facing the sample) is 0.5 um, 1 um, 2 um, 3 um, 5 um, 10 um, 15 um, or a range between any two of the values.

8. The spacers on the Q-Card has a height of 0.5 um, 1 um, 2 um, 3 um, 5 um, 10 um, 15 um, 20 um, 30 um, 50 um, or a range between any two of the values. In some preferred embodiments, the spacers on the Q-Card has a height of 0.5 um, 1 um, 2 um, 3 um, 5 um, 10 um, 15 um, or a range between any two of the values.

9. In the sample region being imaged, the spacing between the two plates is configured to make the saturation time for the binding between the analyte and the probe becoming 10 seconds or less, 20 seconds or less, 30 seconds or less, 60 seconds or less, 90 seconds or less, 120 seconds or less, 240 seconds or less, 300 seconds or less, 500 seconds or less, or a range between any of the two.

In a preferred embodiment, the spacing between the two plates is configured to make the saturation time for the binding between the analyte and the probe become 10 seconds or less, 20 seconds or less, 30 seconds or less, 60 seconds or less, 90 seconds or less, or 120 seconds or less.

Additional descriptions and embodiments are provided to illustrate the described approach in rest of this disclosure, such as the analyte to be assayed, the labels and samples for the fast staining, the adaptor used to take the image of the sample in staining, the imaging device (e.g. microscope or smartphone), the system that performs fast staining, the cell types such as eukaryote or prokaryote in assaying, and the disease and disorders related to the fast assaying of the present invention. During fast staining, cells can be permeated either before or after the formation. Cells can form a monolayer with pillars in the sample holding device, e.g. Q-card, as the reference for imaging the assaying signal with the probe.

The fast staining can be multiplexed, and some embodiments, multiple probes (i.e. different kinds of the probes) are used.

The term “permeabilizing” a cell refers to make the cell allow large molecules such as antibodies and/or nucleic acid to get inside the cell.

And in some embodiments, the sample is whole blood without any liquid dilution.

### More Examples

A1. In some embodiments, a method of fast staining biomaterials without wash, comprising:
   a) depositing the biomaterials on the flat glass slide of a sample holder, wherein the sample holder has two contact plates that can open and close to keep the biomaterial sample in between their gaps, wherein a plurality of monitoring structure pillars placed on a contact surface, wherein the plurality of pillars are placed according to a pattern, and the contact plates contact the sample that contains a plurality of analytes in the biomaterials;
   b) staining the biomaterials by printing the staining reagent on the contact surface or depositing the staining reagent directly on the sample when the sample holder is open, or by the combination of the two;
   c) closing the contact plates of the sample holder, making the sample in contact with staining reagent, taking an image of the sample in the closed sample holder at a short time interval without washing;
   d) splitting the image of fast staining and no wash image of the sample from (c) into disjoint patches, wherein each image patch is surrounded by pillars at its four corners;
   e) feeding the image patches from (d) to an image transformation module that transforms the fast stained and no wash image patch to an image of well stained and washed sample, wherein the image transformation is based on a machine learning model trained with the constraint that the known edge contour of pillars (i.e. position markers) or the inter-distance between pillars, from card fabrication at the vertex of the image patch, are aligned in the transformation; and
   f) collecting and stitching the transformed image patches from (e) into a high resolution stained image for assaying.
A2. In some embodiments, the method of A1, further comprising training an image transformation model that transforms the fast stained and no wash image of biomaterials to its high resolution stained and well washed counterpart in assaying, comprising:
   a) collecting in DB1 a plurality of of fast staining and no wash of biomaterials images with the sample holding plates closed and taking at preset time instant, such as 60 seconds;
   b) segmenting each image in DB1 into pillar surrounded image patches with pillars at its four corners and saving them in DB-A;
   c) collecting in DB2 a plurality of images of well washed and stained images with sample holding plates closed;
   d) segmenting each image in DB2 into pillar surrounded image patches with pillars at its four corners and saving them in DB-B;
   e) taking the image patches in DB-A as input from domain 1 and the image patches in DB-B as input from domain 2, and performing cyclic machine learning model training, such as CycleGAN, with additional constraint that the known edge contour of pillars at the vertex of the image patch, are aligned; and
   f) saving the forward transformation model that transforms the fast staining and no wash image patch to its high resolution, stained and well washed image for fast staining of biomaterials.
A3: In some embodiments, a method of A2, wherein image patches in DB1 and DB2 are paired and aligned further comprising:
   a) pairing the image patch in DB-A with its matching image patch in DB-B to form paired image pairs, where image patches are segmented with pillars at their four corners;
   b) training a machine learning model based on the image-to-image transformation, such as GAN based pixel-to-pixel transform, taking the paired image pairs from (a) as input, and additional constraint that the known edge contour of pillars at the vertex of the image patches, are aligned; and
   c) saving the transformation model that transforms the fast staining and no wash image to its high resolution, stained and well washed counterpart.
A4: In some embodiments, the method of A1, A2 and A3 further comprising:
   a. making the image patches in A1, A2 and A3 oriented to the original direction of the image by using a rectangular pillar with the long edges of the four corner pillars parallel to the y-axis;
   b. detecting the orientation of the pillar surrounded image patch in DB-A and DB-B of A2 and A3 from the pillar orientation of its four corners, and rotating the image patch if needed to make the image patches aligned with its original direction;
   c. applying the directional oriented image patches in training the image transformation model, and orienting the image patches to its original direction in the transformation of fast stain and no wash image patches; and
   d. stitching the transformed image patches to form a high resolution, stained, and well washed image for assaying.
A5: In some embodiments, a method of A1, A2 and A3, wherein the fast stain and no wash are imaged at multiple time instants, further comprising:
   a) collecting all image patches of fast stain and no wash at multiple time instants into one database and training one machine learning transformation model following A2 and A3; or
   b) for each sampling time instants, e.g. 30 s, 60 s, and 90 s, training a separate machine learning transformation models for that time instant following A2 and A3, to transform the fast staining and no wash image taken at that instant to its high quality, stained and well washed counterpart.
A6: In some embodiments, a method of fast staining and no wash that generates high resolution, stained and well washed image for biomaterials from the initial staining steps without washing or waiting for the whole protocol/procedure to complete, comprising:
   a) depositing the biomaterials in a sample holder wherein the plurality of pillars are placed according to a known pattern and shape;
   b) depositing the staining reagent to the biomaterials in the sample holder;
   c) taking the image of fast stained and no wash biomaterials in the sample holder at a pre-specified time instant, such as 60 second;
   d) segmenting the image of fast stained and no wash image into pillar surrounded patches with pillars at the four corners;
   e) performing transformation on each image patch to its high resolution, stained and well washed counterpart using a machine learning model with added constraint that the known contour of pillars at the vertex of the image patch are aligned in the transformation; and
   f) stitching the transformed image patches for a high resolution, stained and well washed image of the biomaterials for assaying.
      The Height of Spacer Above the Biopsy Sample after Pressing

In some embodiments, the average height of spacer above the biopsy sample after pressing is 0.1 um, 0.2 um, 0.5 um, 1 um, 5 um, 10 um, 30 um, 50 um, or a range between any two of the values.

In some embodiments, the preferred average height of spacer above the biopsy sample after pressing is 1 um, 2 um, 3 um, 5 um, 10 um, or a range between any two of the values.

The Height of Spacer Inside the Biopsy Sample after Pressing

In some embodiments, the average height of spacer inside the biopsy sample after pressing is 0.1 um, 0.2 um, 0.5 um, 1 um, 5 um, 10 um, 30 um, 50 um, or a range between any two of the values.

In some embodiments, the preferred average height of spacer inside the biopsy sample after pressing is 1 um, 2 um, 3 um, 5 um, 10 um, or a range between any two of the values.

The Volume of Reagent Solution before Pressing:

In some embodiments, no liquid reagent is added into the device.

In some embodiments, the staining reagent is printed onto one of the plate of the device.

In some embodiments, a liquid reagent is added onto first plate, or biopsy sample or second plate before pressing.

In some embodiments, the volume of liquid reagent added into the device is 0 uL, 1 uL, 2 uL, 3 uL, 5 uL, 10 uL, 20 uL, 30 uL, 50 uL or a range between any two of the values.

### The Thickness of the Flexible Plate Times the Young's Modulus (hE)

In some embodiments, at least one of the plates is a flexible plate, and the thickness of the flexible plate times the Young's modulus of the flexible plate is in the range of 1 GPa·μm to 1000 GPa·μm.

In some embodiments, at least one of the plates is a flexible plate, and the thickness of the flexible plate times the Young's modulus of the flexible plate is in the range of 10 GPa·μm to 500 GPa·μm.

In some embodiments, at least one of the plates is a flexible plate, and the thickness of the flexible plate times the Young's modulus of the flexible plate is preferred in the range of 20 GPa·μm to 150 GPa·μm.

In some embodiments, at least one of the plates is a flexible plate, and the thickness of the flexible plate times the Young's modulus of the flexible plate is preferred in the range of 1 GPa·μm to 20 GPa·μm.

### The Fourth Power of the Inter-Spacer-Distance (ISD) Divided by the Thickness of the Flexible Plate (h) and the Young's Modulus (E):

In some embodiments, a fourth power of the inter-spacer-distance (IDS) divided by the thickness (h) and the Young's modulus (E) of the flexible plate (ISD⁴/(hE)) is 5×10⁶ um³/GPa or less.

In some embodiments, a fourth power of the inter-spacer-distance (IDS) divided by the thickness (h) and the Young's modulus (E) of the flexible plate (ISD⁴/(hE)) is 1×10⁶ um³/GPa or less.

In some embodiments, a fourth power of the inter-spacer-distance (IDS) divided by the thickness (h) and the Young's modulus (E) of the flexible plate (ISD⁴/(hE)) is 5×10⁵ um³/GPa or less.

### The Thickness of the Flexible Plate (h):

In some embodiments, the plate is a flexible plate, and the thickness of the flexible plate is 1 um to 500 um.

In some embodiments, the plate is a flexible plate, and the preferred thickness of the flexible plate is 3 um to 175 um.

In some embodiments, the plate is a flexible plate, and the preferred thickness of the flexible plate is 5 um to 50 um.

### The Young's Modulus (E):

In some embodiments, at least one of the plates is a flexible plate, and the Young's modulus of the flexible plate is 0.01 GPa to 100 GPa.

In some embodiments, at least one of the plates is a flexible plate, and the Young's modulus of the flexible plate is 0.1 GPa to 50 GPa.

In some embodiments, at least one of the plates is a flexible plate, and the preferred Young's modulus of the flexible plate is 1 GPa to 5 GPa.

In some embodiments, at least one of the plates is a flexible plate, and the preferred Young's modulus of the flexible plate is 0.01 GPa to 1 GPa.

### The Staining Time:

In some embodiments, the staining time after closing the card is preferred at 10 sec, 20 sec, 30 sec, 60 sec, 90 sec, 120 sec or a range between any two of the values.

### The Imaging System:

In some embodiments, the imaging system detect signal from sample includes but not limitted to photoluminescence, electroluminescence, and electrochemiluminescence, light absorption, reflection, transmission, diffraction, scattering, or diffusion, surface Raman scattering, electrical impedance selected from resistance, capacitance, and inductance, magnetic relativity and a combination thereof.

In some embodiments, the imaging system is a microscope, a bright field microscope, phase contrast microscope, fluorescence microscope, inverted microscope, the compound light microscope, stereo microscope, digital microscope, acoustic microscope, phone based microscope.

### The Analyzing System:

In some embodiments, the analyzing system includes but not limit to machine learning, supervised machine learning, unsupervised machine learning, and reinforcement learning.

In some embodiments, the analyzing system combines both the software analyzing and human analyzing.

One aspect of the present invention is to provide devices and methods for easy and rapid tissue staining by utilizing a pair of plates that are movable to each other to manipulate a tissue sample and/or a small volume of staining liquid, reducing sample/staining liquid thickness, making a contact between the sample and staining reagent, etc.—all of them have beneficial effects on the tissue staining (simplify and speed up stain, wash free, and save reagent)

Another aspect of the present invention is to provide for easy and rapid tissue staining by coating staining reagents on one or both of the plate(s), which upon contacting the liquid sample and/or the staining liquid, are dissolved and diffused in the sample and/or the staining liquid, easing the handling of staining reagents with no need of professional training.

Another aspect of the present invention is to ensure uniform access of the sample to the staining reagent by utilizing the plates and a plurality of spacers of a uniform height to force the sample and/or staining liquid to form a thin film of uniform thickness, leading to same diffusion distance for the staining reagents across a large lateral area over the sample.

Another aspect of the present invention is to provide systems for easy and rapid tissue staining and imaging by combining the pair of plates for staining with a mobile communication device adapted for acquiring and analyzing images of the tissue sample stained by the plates. Optionally, the mobile communication is configured to send the imaging data and/or analysis results to a remote location for storage and/or further analysis and interpretation by professional staffs or software.

Another aspect of the present invention is to provide devices, systems and methods for immunohistochemistry.

Another aspect of the present invention is to provide devices, systems and methods for H&E stains, special stains, and/or cell viability stains.

Another aspect of the present invention is to provide devices, systems and methods for in situ hybridization.

Another aspect of the present invention is to provide devices, systems and methods for staining biological materials (e.g. for staining of cells or tissues, nucleic acid stains, H&E stains, special stains, and/or cell viability stains. etc.) without washing, and in some embodiments, in a single step.

### Using CROF Cards in Cytology/Cytopathology Screening and Diagnosis

Some embodiments of the present invention are related to collect and analyze a sample using cytology quickly and simply.

According to the present invention, a method of collecting and analyzing a sample using cytology comprising:
a. A sample holding CROF (compressed regulated open flow) card comprising two plates wherein the second plate is movable relative to each other;
b. collecting a biological sample (i.e. biopsy) from a subject (e.g. a human or animal) and depositing a part of or all the sample on an inner surface of a first plate of the card;
c. depositing a staining solution on either (i) surface of the first plate and/or on top of the sample, (ii) inner surface of the second plate, or (iii) both,
d. bringing the two plates together to a closed configuration, wherein the two inner surfaces of the first and second plates are facing each other and the spacing between the plates is regulated by spacers between the plate, and at least a part of the staining solution is between the sample and the inner surface of the second plate;
e. having an imager and imaging the sample in the sample holding card for analysis; and
f. having an analysis module that analyzes the image of the sample and generate the assaying results.

In some embodiments, the analysis by imaging is cyto-analysis.

In some embodiments, the spacers are fixed on one or both plates, and in some embodiments, the spacers are inside of the staining solution.

In some embodiments, the sample is mixed with the staining solution before dropped on the plate.

In some embodiments, the staining solution comprises staining agent (things that stain cells/tissue) in a solution. In some embodiments, the staining is configured to transport a staining agent coated on one of the plates into the cells/tissue. In some embodiments, the staining solution comprises staining agent (things that stain cells/tissue) in a solution, and is configured to transport a staining agent coated on one of the plates into the cells/tissue.

In some embodiments, the spacer height is configured to make the stained cells and/or tissues be visible by an imaging device without washing away the staining solution between the second plate and the sample.

In some embodiments, the spacer height is configured to make the stained cells and/or tissues be visible by an imaging device without open the plates after the plates reached a closed configuration.

In some embodiments, a sample is stained without washing away the staining solution between the second plate and the sample, and imaged by an imager, after closing the plates into a closed configuration, in 30 seconds or less, 60 seconds or less, 120 seconds or less, 300 seconds or less, 600 seconds or less, or a range between any of the two.

In some preferred embodiments, a sample was stained without washing away the staining solution between the second plate and the sample, and imaged by an imager, after closing the plates into a closed configuration, in 30 seconds or less, 60 seconds or less, 120 seconds or less, or a range between any of the two.

In some preferred embodiments, a sample was stained without washing away the staining solution between the second plate and the sample, and imaged by an imager, after closing the plates into a closed configuration, in 30 seconds or less, 60 seconds or less, or a range between any of the two.

In some embodiments, the spacer height is 0.2 um (micron) or less, 0.5 um or less, 1 um or less, 3 um or less, 5 um or less, 10 um or less, 20 um or less, 30 um or less, 40 um or less, 50 um or less, or a range between any of the two.

In some preferred embodiments, the spacer height is 3 um or less. In some preferred embodiments, 10 um or less. In some preferred embodiments, 20 um or less. In some preferred embodiments, 30 um or less.

In some preferred embodiments, the staining solution has, after the plates are in a closed configuration, a thickness that is equal or less than sub-noise thickness.

The term “sub-noise thickness” (SNT) reference to the a thickness of a sample or a staining solution, which is thinner than a thickness that the optical label is visible to an imager from the noise in the sample or in the staining solution. Making a staining solution less than the SNT will remove the need to wash away the unbind optical labels.

Example of oral cancer diagnostics. According to the present invention, the sample is epithelial cells that exfoliated by a swab from the mouth of a subject. An oral cancer diagnostics can be done by measuring the size and/or area of an epithelial cell and its nucleus, and/or by measuring the ratio of the size and/or of them. For example, a cancer epithelial cell typically has an epithelial cell and its nucleus area ratio larger than the ratio of a norm epithelial cell.

Example of screen smoker from non-smoker. According to the present invention, the sample is epithelial cells that exfoliated by a swab from the mouth of a subject. A smoker has a different epithelial cell and its nucleus area ratio compared to a non-smoker.

One application of the present invention is in cytopathology. Cytopathology is commonly used to investigate disease at cellular level using free cells or tissue fragments removed from a wide range of body sites. It has been the main tool utilized to screen and diagnose cancer and some infectious diseases or other inflammatory conditions. For example, a common application of cytopathology is the Pap smear, a screening tool used to detect precancerous cervical lesions that may lead to cervical cancer.

For some embodiments, the QMAX device is used to process (press) biopsy material to monolayer. In some embodiments, a biopsy sample is removed from the body by using one or a combination of the following methods: needle aspiration, endoscopy and excisional or incisional surgery.

a. needle biopsy from skin lesion, lymph node, thyroid, mammary gland, lung and body cavity
b. tissue Smear from oral brush material, cervical (pap smear), body fluid: urine, sputum (phlegm), spinal fluid, pleural fluid, pericardial fluid, ascitic fluid
c. endoscopy biopsy from
   i. GI tract: esophagus, stomach, and duodenum (esophagogastroduodenoscopy), small intestine (enteroscopy), large intestine/colon (colonoscopy, sigmoidoscopy), bile duct, rectum (rectoscopy), and anus (anoscopy);
   ii. respiratory tract: nose (rhinoscopy), lower respiratory tract (fiberoptic bronchoscopy)
   iii. Ear: otoscopy
   iv. urinary tract: cystoscopy
   v. female reproductive tract (gynoscopy): cervix (colposcopy), uterus (hysteroscopy), fallopian tubes (falloposcopy).
   vi. through a small incision: abdominal or pelvic cavity (laparoscopy), interior of a joint (arthroscopy), organs of the chest (thoracoscopy and mediastinoscopy).
d. Surgery biopsy from any excisionally or incisionally removed tissue or mass
e. In certain embodiments, the QMAX device is used to stain any molecular, organelle, cellular, outer cellular or organoid structure, for example,
f. biological molecule includes, but not limited to: protein, peptide, amino acids (selenocysteine, pyrrolysine, carnitine, ornithine, GABA and taurine). lipid (glycolipids, phospholipids, sterols, arachidonic acid, prostaglandins, leukotrienes), fatty acids, carbohydrates (monosaccharides, disaccharides, polysaccharides), nucleic acids (nucleotide, oligonucleotide, polynucleotides), any catabolites, any metabolites, secondary metabolites, vitamins, reactive oxygen/nitrogen species, minerals, polyphenolic macromolecule, and other small molecules.
g. modification/reaction of biological molecules include, but not limited to: phosphorylation, methylation, acetylation, lipidation, thiol reactions, amine reaction, carboxylate reactions, hydroxyl reactions, aldehyde and ketone reactions.
h. cellular organelle/subcellular structure include, but not limited to: nucleus, ribosome, peroxisomes, endoplasmic reticulum, golgi apparatus, mitochondria, lysosome, cell membrane, endosome, exosome, cytoskeleton.
i. type of cells with any physiological/pathological conditions include, but not limited to:

within a tumor (can be originated from any epithelial from any organ, and vessel endothelial cells, fibroblast, lymphocyte), neuronal cells, lipocytes, stromal cells, chondrocytes, retinal cells, glial cells, smooth muscle cells, any type of stem cells, any type of embryonic cells, any type of endocrine cells, any type of exocrine cells, any type of immune cells, dendritic cells, myeloid cells, hematopoietic cells, lymphocyte . . . ; normal cells, benign cells, premalignant cells, malignant cells, transformation cells, quiescent cells, proliferation cells, apoptotic cells, senescent cells, mitotic cells, inflammatory cells, hyperplasia cells, hypertrophy cells, atrophy cells, hyperplasia cells, dysplasia cells, metaplasia cells, . . .
j. connective tissue/extracellular structures include, but not limited to: Loose ordinary connective tissue, adipose tissue, blood and blood forming tissues, dense ordinary connective tissue, cartilage, bone, any type of extracellular vesicles, extracellular matrix, platelet . . .

In some embodiments, the QMAX devices is used to following staining methods:

a. Dye Staining
i. Papanicolaou staining: Harris hematoxylin; orange G6; EA50 (eosin Y, light green SF)
ii. May-Grunwald Giemsa staining (eosin G, methylene blue)
iii. Ziehl-Neelsen stain
iv. Modified Ziehl Neelson (for acid fast bacilli), Gram staining (Bacteria), Mucicarmine (mucins), PAS (for glycogen, fungal wall, lipofuscin, etc), Oil red O (lipids), Perl's Prussian blue (iron), modified Fouchet's test (bilirubin),
v. any fluorescent/non-fluorescent dye for biological molecule, organelles, cells and biological structures, for example nuclei acid dyes: cyanine dyes (PicoGreen, OliGreen and RiboGreen, SYBR Gold, SYBR Green I and SYBR Green II, CyQUANT GR dye), cyanine dimer dyes (SYTOX, POPO-1, TOTO-1, YOYO-1, BOBO-1, JOJO-1, POPO-3, LOLO-1, TOTO-3, PO-PRO-1, JO-PRO-1, YO-PRO-1, PO-PRO-3, YO-PRO-3, TO-PRO-3, TO-PRO-5), amine-reactive cyanine dye (SYBR 101 dye), phenanthridines and acridines (ethidium bromide (EB) and ethidium homodimer-1, propidium iodide (PI), acridine orange (AO), hexidium iodide, dihydroethidium, ethidium homodimer-1, ethidium homodimer-2, ethidium monoazide, acridine homodimer bis-(6-chloro-2-methoxy-9-acridinyl)spermine, ACLMA), Indoles and Imidazoles (Hoechst 33258. Hoechst 33342, Hoechst 34580, DAPI), 7-Aminoactinomycin D and Actinomycin D, Hydroxystilbamidine, LDS 751, Nissl Stains
   b. IHC/IF Staining
i. Direct method, indirect method, PAP method (peroxidase anti-peroxidase method), Avidin-Biotin Complex (ABC) Method, Labeled StreptAvidin Biotin (LSAB) Method, Polymeric Methods (EnVision Systems based on dextran polymer technology, ImmPRESS polymerized reporter enzyme staining system), CAS system (from DAKO), CSA II—Biotin-free Tyramide Signal Amplification System
   c. ISH/FISH
i. Method: direct and indirect methods
ii. probes: double-stranded DNA (dsDNA) probes, single-stranded DNA (ssDNA) probes, RNA probes (riboprobes), synthetic oligonucleotides labelling probes: for example, DIG (digoxigenin), biotin, fluorophore (FITC, alexa, tyramide, etc.)
   d. Other Materials

Acridine orange (50 ug/ml, from . . . ) and hematoxylin staining solution (from Vector Laboratories) were used in some embodiments.

Sample holders. The sample holder Q-card comprises two parallel plates with spacers/pillars that have a substantially uniform height and a nearly uniform cross-section seperated from one another by a consistent, pre-defined, distance.

In some embodiments, the movable plate of the Q-card is 175 um thick PMMA with a pillar array of 30×40 um pillar size, 10 um pillar height and 80 um inter space distance. In some embodiment, the Q-Card movable plate is 175 um thick PMMA with a pillar array of 40 um diameter pillar size, 10 m pillar height and 120 um inter pillar space distance.

### Sample

It should be noted that, the term “sample” as used herein, unless otherwise specified, refers to a liquid bio/chemical sample or a non-liquid sample.

In some embodiments, the liquid sample is originally obtained in a liquid form, such as, blood and saliva. In some embodiments, the originally obtained sample specimen is not in a liquid state, for instance, in a solid state or a gaseous state. In such cases, the non-liquid sample is converted to a liquid form when being collected and preserved using the device and method provided by the present disclosure. The method for such conversion includes, but not limited to, mixture with a liquid medium without dissolution (the end product is a suspension), dissolution in a liquid medium, melting into a liquid form from a solid form, condensation into a liquid form from a gaseous form (e.g. exhaled breath condensate).

In some embodiments, the sample can be dried thereon at the open configuration, and wherein the sample comprises bodily fluid selected from the group consisting of:

amniotic fluid, aqueous humour, vitreous humour, blood (e.g., whole blood, fractionated blood, plasma or serum), breast milk, cerebrospinal fluid (CSF), cerumen (earwax), chyle, chime, endolymph, perilymph, feces, breath, gastric acid, gastric juice, lymph, mucus (including nasal drainage and phlegm), pericardial fluid, peritoneal fluid, pleural fluid, pus, rheum, saliva, exhaled breath condensates, sebum, semen, sputum, sweat, synovial fluid, tears, vomit, urine, and any combination thereof.

In some embodiments, the sample contact area of one or both of the plates is configured such that the sample can be dried thereon at the open configuration, and the sample comprises blood smear and is dried on one or both plates.

In some embodiments, the sample is a solid sample, for instance, a tissue section. In some embodiments, the sample is a solid tissue section having a thickness in the range of 1-200 μm. In some embodiments, the sample contact area of one or both of the plates is adhesive to the sample. In some embodiments, the sample is paraffin-embedded. In some embodiments, the sample is fixed (e.g., formalin, paraformaldehyde and the like).

### Staining Liquid

In some embodiments, one primary function of the staining liquid is to serve a transfer medium. The reagents stored (dried/coated) on the plate(s), upon contacting the staining liquid, are dissolved and diffuse in the staining liquid. As such, the staining liquid serves as a transfer medium to provide access for the reagents stored on the plate(s) to the sample.

In some embodiments, one primary function of the staining liquid is to serve as a holding solution. When the plates are pressed to enter the closed configuration, in some embodiments, the plates are configured to “self-hold” at closed configuration after the removal of the external compressing force, due to forces like capillary force provided by the liquid sample. In the cases where the sample specimen is not in a liquid form, the liquid medium therefore provides such forces like capillary force needed for the “self-holding” of the plates.

In some embodiments, the staining liquid comprises buffer pairs to balance the pH value of the final solution. In some embodiments, the staining liquid does not comprise particular component capable of altering the properties of the sample.

In some embodiments, the staining liquid comprises reagents needed for the processing, fixation, or staining of the sample, as further discussed in details in the following sections.

In some embodiments, the staining liquid comprises fixative capable of fixing the sample.

In some embodiments, the staining liquid comprises blocking agents, wherein the blocking agents are configured to disable non-specific endogenous species in the sample to react with detection agents that are used to specifically label the target analyte.

In some embodiments, the staining liquid comprises deparaffinizing agents capable of removing paraffin in the sample.

In some embodiments, the staining liquid comprises permeabilizing agents capable of permeabilizing cells in the tissue sample that contain the target analyte.

In some embodiments, the staining liquid comprises antigen retrieval agents capable of facilitating retrieval of antigen. In some embodiments, the staining liquid comprises detection agents that specifically label the target analyte in the sample.

Plate Storage Site

In some embodiments, the sample contact area of one or both plates comprise a storage site that contains reagents needed for the processing, fixation, or staining of the sample. These reagents, upon contacting the liquid sample or the staining liquid, are dissolved and diffuse in the liquid sample/staining liquid.

In some embodiments, the sample contact area of one or both plates comprise a storage site that contains blocking agents, wherein the blocking agents are configured to disable non-specific endogenous species in the sample to react with detection agents that are used to specifically label the target analyte.

In some embodiments, the sample contact area of one or both plates comprise a storage site that contains deparaffinizing agents capable of removing paraffin in the sample. In some embodiments. the sample contact area of one or both plates comprise a storage site that contains permeabilizing agents capable of permeabilizing cells in the tissue sample that contain the target analyte.

In some embodiments. the sample contact area of one or both plates comprise a storage site that contains antigen retrieval agents capable of facilitating retrieval of antigen. In some embodiments, the sample contact area of one or both plates comprise a storage site that contains detection agents that specifically label the target analyte in the sample.

In some embodiments, the sample contact area of one or both of the plates comprise a binding site that contains capture agents, wherein the capture agents are configured to bind to the target analyte on the surface of cells in the sample and immobilize the cells.

Detection Agent

In some embodiments, the detection agent comprises dyes for a stain selected from the group consisting of: Acid fuchsin, Alcian blue 8 GX, Alizarin red S, Aniline blue WS, Auramine O, Azocarmine B, Azocarmine G, Azure A, Azure B, Azure C, Basic fuchsine, Bismarck brown Y, Brilliant cresyl blue, Brilliant green, Carmine, Chlorazol black E, Congo red, C.I. Cresyl violet, Crystal violet, Darrow red, Eosin B, Eosin Y, Erythrosin, Ethyl eosin, Ethyl green, Fast green F C F, Fluorescein Isothiocyanate, Giemsa Stain, Hematoxylin, Hematoxylin & Eosin, Indigo carmine, Janus green B, Jenner stain 1899, Light green SF, Malachite green, Martius yellow, Methyl orange, Methyl violet 2B, Methylene blue, Methylene blue, Methylene violet, (Bernthsen), Neutral red, Nigrosin, Nile blue A, Nuclear fast red, Oil Red, Orange G, Orange II, Orcein, Pararosaniline, Phloxin B, Protargol S, Pyronine B, Pyronine, Resazurin, Rose Bengal, Safranine O, Sudan black B, Sudan III, Sudan IV, Tetrachrome stain (MacNeal), Thionine, Toluidine blue, Weigert, Wright stain, and any combination thereof.

In some embodiments, the detection agent comprises antibodies configured to specifically bind to protein analyte in the sample.

In some embodiments, the detection agent comprises oligonucleotide probes configured to specifically bind to DNA and/or RNA in the sample.

In some embodiments, the detection agent is labeled with a reporter molecule, wherein the reporter molecule is configured to provide a detectable signal to be read and analyzed.

In some embodiments, the reporter molecule comprises fluorescent molecules (fluorophores), including, but not limited to, IRDye800CW, Alexa 790, Dylight 800, fluorescein, fluorescein isothiocyanate, succinimidyl esters of carboxyfluorescein, succinimidyl esters of fluorescein, 5-isomer of fluorescein dichlorotriazine, caged carboxyfluorescein-alanine-carboxamide, Oregon Green 488, Oregon Green 514; Lucifer Yellow, acridine Orange, rhodamine, tetramethylrhodamine, Texas Red, propidium iodide, JC-1 (5,5′,6,6′-tetrachloro-1,1′,3,3′-tetraethylbenzimidazoylcarbocyanine iodide), tetrabromorhodamine 123, rhodamine 6G, TMRM (tetramethyl rhodamine methyl ester), TMRE (tetramethyl rhodamine ethyl ester), tetramethylrosamine, rhodamine B and 4-di methylaminotetramethylrosamine, green fluorescent protein, blue-shifted green fluorescent protein, cyan-shifted green fluorescent protein, redshifted green fluorescent protein, yellow-shifted green fluorescent protein, 4-acetamido-4′-isothiocyanatostilbene-2,2′disulfonic acid; acridine and derivatives, such as acridine, acridine isothiocyanate; 5-(2′-aminoethyl)aminonaphthalene-1-sulfonic acid (EDANS); 4-amino-N-[3-vinylsulfonyl)phenyl]naphth-alimide-3,5 disulfonate; N-(4-anilino-1-naphthyl)maleimide; anthranilamide; 4,4-difluoro-5-(2-thienyl)-4-bora-3a,4a diaza-5-indacene-3-propioni-c acid BODIPY; cascade blue; Brilliant Yellow; coumarin and derivatives: coumarin, 7-amino-4-methylcoumarin (AMC, Coumarin 120),7-amino-4-trifluoromethylcoumarin (Coumarin 151); cyanine dyes; cyanosine; 4′,6-diaminidino-2-phenylindole (DAPI); 5′,5″-dibromopyrogallol sulfonaphthalein (Bromopyrogallol Red); 7-diethylamino-3-(4′-isothiocyanatophenyl)-4-methylcoumarin; diethylenetriaamine pentaacetate; 4,4′-di isothiocyanatodihydro-stilbene-2-,2′-disulfonic acid; 4,4′-diisothiocyanatostilbene-2,2′-disulfonic acid; 5-(dimethylamino]naphthalene-1-sulfonyl chloride (DNS, dansylchloride); 4-dimethylaminophenylazophenyl-4′-isothiocyanate (DABITC); eosin and derivatives: eosin, eosin isothiocyanate, erythrosin and derivatives: erythrosin B, erythrosin, isothiocyanate; ethidium; fluorescein and derivatives: 5-carboxyfluorescein (FAM),5-(4,6-dichlorotriazin-2-yl)amino-fluorescein (DTAF), 2′,7′dimethoxy-4′5′-dichloro-6-carboxyfluorescein (JOE), fluorescein, fluorescein isothiocyanate, QFITC, (XRITC); fluorescamine; 1R144; 1R1446; Malachite Green isothiocyanate; 4-methylumbelliferoneortho cresolphthalein; nitrotyrosine; pararosaniline; Phenol Red; B-phycoerythrin; ophthaldialdehyde; pyrene and derivatives: pyrene, pyrene butyrate, succinimidyl 1-pyrene; butyrate quantum dots; Reactive Red 4 (Cibacron™ Brilliant Red 3B-A) rhodamine and derivatives: 6-carboxy-X-rhodamine (ROX), 6-carboxyrhodamine (R6G), lissamine rhodamine B sulfonyl chloride rhodamine (Rhod), rhodamine B, rhodamine 123, rhodamine X isothiocyanate, sulforhodamine B, sulforhodamine 101, sulfonyl chloride derivative of 5 sulforhodamine (Texas Red); N,N,N′,N′-tetramethyl-6-carboxyrhodamine (TAMRA); tetramethyl rhodamine; tetramethyl hodamine isothiocyanate (TRITC); riboflavin; 5-(2′-aminoethyl) aminonaphthalene-1-sulfonic acid (EDANS), 4-(4′-dimethylaminophenylazo)benzoic acid (DABCYL), rosolic acid; CAL Fluor Orange 560; terbium chelate derivatives; Cy 3; Cy 5; Cy 5.5; Cy 7; IRD 700; IRD 800; La Jolla Blue; phthalo cyanine; and naphthalo cyanine, coumarins and related dyes, xanthene dyes such as rhodols, resorufins, bimanes, acridines, isoindoles, dansyl dyes, aminophthalic hydrazides such as luminol, and isoluminol derivatives, aminophthalimides, aminonaphthalimides, aminobenzofurans, aminoquinolines, dicyanohydroquinones, fluorescent europium and terbium complexes; combinations thereof, and the like. Suitable fluorescent proteins and chromogenic proteins include, but are not limited to, a green fluorescent protein (GFP), including, but not limited to, a GFP derived from Aequoria victoria or a derivative thereof, e.g., a “humanized” derivative such as Enhanced GFP; a GFP from another species such as Renilla reniformis, Renilla mulleri, or Ptilosarcus guernyi; “humanized” recombinant GFP (hrGFP); any of a variety of fluorescent and colored proteins from Anthozoan species; any combination thereof; and the like.

In some embodiments, the signal is selected from the group consisting of:
i. luminescence selected from photo-luminescence, electroluminescence, and electro-chemiluminescence;
ii. light absorption, reflection, transmission, diffraction, scattering, or diffusion;
iii. surface Raman scattering;
iv. electrical impedance selected from resistance, capacitance, and inductance;
v. magnetic relaxivity; and
vi. any combination of i-v.

Immunohistochemistry

In some embodiments, the devices and methods of the present disclosure are useful for conducting immunohistochemistry on the sample.

In immunohistochemical (IHC) staining methods, a tissue sample is fixed (e.g., in paraformaldehyde), optionally embedding in wax, sliced into thin sections that are less then 100 μm thick (e.g., 2 μm to 6 μm thick), and then mounted onto a support such as a glass slide. Once mounted, the tissue sections may be dehydrated using alcohol washes of increasing concentrations and cleared using a detergent such as xylene. In certain cases, fixation is also an optional step, for instance, for blood smear staining.

In most IHC methods, a primary and a secondary antibody may be used. In such methods, the primary antibody binds to antigen of interest (e.g., a biomarker) and is unlabeled. The secondary antibody binds to the primary antibody and directly conjugated either to a reporter molecule or to a linker molecule (e.g., biotin) that can recruit reporter molecule that is in solution. Alternatively, the primary antibody itself may be directly conjugated either to a reporter molecule or to a linker molecule (e.g., biotin) that can recruit reporter molecule that is in solution. Reporter molecules include fluorophores (e.g., FITC, TRITC, AMCA, fluorescein and rhodamine) and enzymes such as alkaline phosphatase (AP) and horseradish peroxidase (HRP), for which there are a variety of fluorogenic, chromogenic and chemiluminescent substrates such as DAB or BCIP/NBT.

In direct methods, the tissue section is incubated with a labeled primary antibody (e.g. an FITC-conjugated antibody) in binding buffer. The primary antibody binds directly with the antigen in the tissue section and, after the tissue section has been washed to remove any unbound primary antibody, the section is to be analyzed by microscopy.

In indirect methods, the tissue section is incubated with an unlabeled primary antibody that binds to the target antigen in the tissue. After the tissue section is washed to remove unbound primary antibody, the tissue section is incubated with a labeled secondary antibody that binds to the primary antibody.

After immunohistochemical staining of the antigen, the tissue sample may be stained with another dye, e.g., hematoxylin, Hoechst stain and DAPI, to provide contrast and/or identify other features.

The present device may be used for immunohistochemical (IHC) staining a tissue sample. In these embodiments, the device may comprise a first plate and a second plate, wherein: the plates are movable relative to each other into different configurations; one or both plates are flexible; each of the plates has, on its respective surface, a sample contact area for contacting a tissue sample or a IHC staining liquid; the sample contact area in the first plate is smooth and planner; the sample contact area in the second plate comprise spacers that are fixed on the surface and have a predetermined substantially uniform height and a predetermined constant inter-spacer distance that is in the range of 7 μm to 200 μm;

wherein one of the configurations is an open configuration, in which: the two plates are completely or partially separated apart, the spacing between the plates is not regulated by the spacers; and wherein another of the configurations is a closed configuration which is configured after a deposition of the sample and the IHC staining liquid in the open configuration; and in the closed configuration: at least part of the sample is between the two plates and a layer of at least part of staining liquid is between the at least part of the sample and the second plate, wherein the thickness of the at least part of staining liquid layer is regulated by the plates, the sample, and the spacers, and has an average distance between the sample surface and the second plate surface is equal or less than 250 μm with a small variation.

As discussed above, in some embodiments, the device may comprise a dry IHC staining agent coated on the sample contact area of one or both plates. In some embodiments, the device may comprise a dry IHC staining agent coated on the sample contact area of the second plate, and the IHC staining liquid comprise a liquid that dissolve the dry IHC staining agent. In some embodiments, the thickness of the sample is 2 μm to 6 μm.

H&E, Special Stains, and Cell Viability Stains

In some embodiments, the devices and methods of the present disclosure are useful for conducting H&E stain, special stains, and cell viability stains.

Hematoxylin and eosin stain or haematoxylin and eosin stain (H&E stain or HE stain) is one of the principal stains in histology. It is the most widely used stain in medical diagnosis and is often the gold standard; for example when a pathologist looks at a biopsy of a suspected cancer, the histological section is likely to be stained with H&E and termed “H&E section”, “H+E section”, or “HE section”. A combination of hematoxylin and eosin, it produces blues, violets, and reds.

In diagnostic pathology, the “special stain” terminology is most commonly used in the clinical environment, and simply means any technique other than the H&E method that is used to impart colors to a specimen. This also includes immunohistochemical and in situ hybridization stains. On the other hand, the H&E stain is the most popular staining method in histology and medical diagnosis laboratories. In any embodiments, the dry binding site may comprise a capture agent such as an antibody or nucleic acid. In some embodiments, the releasable dry reagent may be a labeled reagent such as a fluorescently-labeled reagent, e.g., a fluorescently-labeled antibody or a cell stain such Romanowsky's stain, Leishman stain, May-Grunwald stain, Giemsa stain, Jenner's stain, Wright's stain, or any combination of the same (e.g., Wright-Giemsa stain). Such a stain may comprise eosin Y or eosin B with methylene blue. In certain embodiments, the stain may be an alkaline stain such as haematoxylin.

In some embodiments, the special stains include, but not limited to, Acid fuchsin, Alcian blue 8 GX, Alizarin red S, Aniline blue WS, Auramine O, Azocarmine B, Azocarmine G, Azure A, Azure B, Azure C, Basic fuchsine, Bismarck brown Y, Brilliant cresyl blue, Brilliant green, Carmine, Chlorazol black E, Congo red, C.I. Cresyl violet, Crystal violet, Darrow red, Eosin B, Eosin Y, Erythrosin, Ethyl eosin, Ethyl green, Fast green F C F, Fluorescein Isothiocyanate, Giemsa Stain, Hematoxylin, Hematoxylin & Eosin, Indigo carmine, Janus green B, Jenner stain 1899, Light green SF, Malachite green, Martius yellow, Methyl orange, Methyl violet 2B, Methylene blue, Methylene blue, Methylene violet, (Bernthsen), Neutral red, Nigrosin, Nile blue A, Nuclear fast red, Oil Red, Orange G, Orange II, Orcein, Pararosaniline, Phloxin B, Protargol S, Pyronine B, Pyronine, Resazurin, Rose Bengal, Safranine O, Sudan black B, Sudan III, Sudan IV, Tetrachrome stain (MacNeal), Thionine, Toluidine blue, Weigert, Wright stain, and any combination thereof.

The term “cell viability stains” refers to staining technology used to differentially stain live cells and dead cells inside a tissue sample. Usually the difference in cell membrane and/or nucleus membrane permeability between live and dead cells are taken advantage for the differential staining. In other cases, markers for apoptosis or necrosis (indicating dying cells or cell corpses) are used for such staining.

In some embodiments, the device comprises, on one or both of the plates, a dye to stain the sample for cell viability. In some embodiments, the dye includes, but not limited to,

Propidium Iodide (PI), 7-AAD (7-Aminoactinomycin D), Trypan blue, Calcein Violet AM, Calcein AM, Fixable Viability Dye (FVD) conjugated with different fluorophores, SYTO9 and other nucleic acid dyes, Resazurin and Formazan (MTT/XTT) and other mitochondrial dyes, and any combination thereof and the like. In some embodiments, the sample comprises bacteria, and it is desirable to determine the bacterial viability in the sample, the device further comprises, on one or both of the plates, a bacterial viability dye, for instance, PI, SYTO9, and the like, to differentially stain the live cells versus dead cells. Optionally, the device further comprises, on one or both of the plates, dyes for total bacterial staining, for instance, gram staining reagents and the like.

### In Situ Hybridization

In some embodiments, the devices and methods of the present disclosure are useful for conducting in situ hybridization (ISH) on histological samples.

In situ hybridization (ISH) is a type of hybridization that uses a labeled complementary DNA, RNA or modified nucleic acids strand (i.e., probe) to localize a specific DNA or RNA sequence in a portion or section of tissue (in situ), or, if the tissue is small enough (e.g., plant seeds, Drosophila embryos), in the entire tissue (whole mount ISH), in cells, and in circulating tumor cells (CTCs).

In situ hybridization is used to reveal the location of specific nucleic acid sequences on chromosomes or in tissues, a crucial step for understanding the organization, regulation, and function of genes. The key techniques currently in use include: in situ hybridization to mRNA with oligonucleotide and RNA probes (both radio-labelled and hapten-labelled); analysis with light and electron microscopes; whole mount in situ hybridization; double detection of RNAs and RNA plus protein; and fluorescent in situ hybridization to detect chromosomal sequences. DNA ISH can be used to determine the structure of chromosomes. Fluorescent DNA ISH (FISH) can, for example, be used in medical diagnostics to assess chromosomal integrity. RNA ISH (RNA in situ hybridization) is used to measure and localize RNAs (mRNAs, IncRNAs, and miRNAs) within tissue sections, cells, whole mounts, and circulating tumor cells (CTCs).

In some embodiments, the detection agent comprises nucleic acid probes for in situ hybridization staining. The nucleic acid probes include, but not limited to, oligonucleotide probes configured to specifically bind to DNA and/or RNA in the sample.

1. A method of staining and imaging a sample without wash, comprising:
(a) providing a first plate and a second plate;
(b) sandwich the sample and a staining reagent between the first plate and the second plate, wherein the staining reagent stains the sample;
(c) capturing a first image of the stained sample without a wash, wherein the wash removes at least a part of the staining reagent; and
(d) generating a target image of the stained sample from the first image using a machine learning algorithm;
wherein the machine learning algorithm is trained using a training data set that comprises at least one image of the stained sample without a wash and at least one image of the stained sample with a wash.

2. A kit for performing the method of claim 1, comprising:
(a) a first plate and a second plate that face each other and are separated by a spacing;
(b) a staining reagent of a concentration that stains the sample for analysis;
wherein the spacing and the concentration are selected such that when the sample and the staining reagent are sandwiched between the first plate and the second plate and are imaged without wash, a staining of the sample is visible.

3. A system for staining and imaging a sample, comprising:
(a) the kit of claim 2; (b) an imager for capturing the image of the stained sample between the first and the second plate;
(c) a non-transitory storage media storing a machine learning algorithm that generates a target image from the image of the stained sample;
wherein the machine learning algorithm is trained using a training data set that comprises at least one image of the stained sample without a wash and at least one image of the stained sample with a wash.

4. The method of claim 1, wherein the machine learning algorithm is trained using a training data set that comprises at least one image of the at least three position markers and the stained sample that is stained in a first set of conditions, and at least one image of the stained sample that is stained in a second set of conditions.

5. The kit of claim 2, wherein one or both of the first and second plates comprise at least three position markers, wherein each pair of the at least three position markers has a predetermined distance between them.

6. The system of claim 3, wherein the machine learning algorithm is trained using a training data set that comprises at least one image of the at least three position markers and the stained sample that is stained in a first set of conditions, and at least one image of the stained sample that is stained in a second set of conditions.

7. The method of claim 1 further comprising spacers that regulate the distance between the first plate and the second plate.

8. The method of claim 7, wherein the spacing between the two plates or the height of the spacers is selected between 0.5 um to 30 um.

9. The method of claim 7, wherein the spacing between the two plates or the height of the spacers is 10 um.

10. The method of claim 1, wherein the first and second plates are movable relative to each other.

11. The method of claim 7, wherein the spacing between the two plates or the spacer height is selected to have a stain saturation time of 5 sec, 10 sec, 20 sec, 30 sec, 60 sec, or a range between any two of the values.

12. (canceled)

13. The method of claim 1, wherein the sample is a tissue.

14. The method of claim 1, wherein the machine learning algorithm employs CycleGAN.

15. The method of claim 1, wherein the machine learning algorithm employs GAN based pixel-to-pixel transform.

16. The method of claim 1, wherein the machine learning algorithm is trained using a training data set that comprises at least one image of the at least three position markers and the stained sample that is stained in a first set of conditions, and at least one image of the stained sample that is stained in a second set of conditions.

17. The method of claim 1, wherein the machine learning algorithm employs at least four position markers.

18. The method of claim 1, wherein the machine learning algorithm employs the position markers that have a geometry and/or a inter distance between the position markers in x-direction different from that in y-direction which is orthogonal to the x-direction.

19. The method of claim 1, wherein the sample comprises bodily fluid selected from the group consisting of amniotic fluid, aqueous humour, vitreous humour, blood, breast milk, cerebrospinal fluid (CSF), cerumen (earwax), chyle, chime, endolymph, perilymph, feces, breath, gastric acid, gastric juice, lymph, mucus, pericardial fluid, peritoneal fluid, pleural fluid, pus, rheum, saliva, exhaled breath condensates, sebum, semen, sputum, sweat, synovial fluid, tears, vomit, urine, and any combination thereof.

20. The method of claim 1, wherein the staining comprises H&E staining, immunohistochemical staining, immuno-fluorescence staining, in situ hybridization staining, or any combination of thereof.

21. The method of claim 1, wherein the staining reagent comprises a dry staining reagent coated on the surface of at least one of the plates.

22. The method of claim 1, wherein the staining reagent is a dry staining reagent coated on the surface of at least one of the plates, and wherein the staining solution is a transfer liquid that transfer the dry stain agent into the sample.

23. The method of claim 7, wherein the spacers are position markers.

24. The method of claim 7, wherein the inter-spacer-distance between neighboring spacers or between neighboring position markers is in the range of 50 μm to 120 μm.

25. The method of claim 7, wherein one or both of the first and second plates are flexible, wherein the thickness of the flexible plate times the Young's modulus of the flexible plate is in the range of 60 to 750 GPa-μm, and wherein the fourth power of the inter-spacer-distance (ISD) divided by the thickness of the flexible plate (h) and the Young's modulus (E) of the flexible plate, ISD⁴/(hE), is equal to or less than 10⁶ μm³/GPa.

26. The method of claim 7, wherein one or both of the first and second plates are flexible; wherein the spacer height is selected in the range of 0.5 to 50 μm, the IsD is 100 μm or less, the fourth power of the inter-spacer-distance (ISD) divided by the thickness (h) and the Young's modulus (E) of the flexible plate (ISD⁴/(hE)) is 5×10⁵ μm³/GPa or less; the thickness of the flexible plate times the Young's modulus of the flexible plate is in the range of 60 to 750 GPa-μm.

27. The kit of claim 2, wherein one or both of the first and second plates comprises the spacers that regulate the distance between the first plate and the second plate.

28. The kit of claim 27, wherein the spacing between the two plates or the height of the spacers is selected between 0.5 μm to 30 μm.

29. The kit of claim 27, wherein the spacing between the two plates or the height of the spacers is 10 μm.

30. The kit of claim 2, wherein the first and second plates are movable relative to each other.

31. The kit of claim 27, wherein the spacing between the two plates or the spacer height is selected to have a stain saturation time of 5 sec, 10 sec, 20 sec, 30 sec, 60 sec, or a range between any two of the values.

32. The kit of claim 2, wherein the staining reagent comprises the agent for H&E staining, immunohistochemical staining, immuno-fluorescence staining, in situ hybridization staining, or any combination of thereof.

33. The kit of claim 2, wherein the staining reagent comprises a dry staining reagent coated on the surface of at least one of the plates.

34. The kit of claim 2, wherein the kit further comprises a transfer liquid between the sample and the second plate; wherein the staining reagent comprises a dry staining reagent coated on the surface of at least one of the plates, and wherein the transfer liquid transfers the dry staining reagent to the sample.

35. The kit of claim 27, wherein the spacers are position markers.

36. The kit of claim 27, wherein the inter-spacer-distance between neighboring spacers or between neighboring position markers is in the range of 50 μm to 120 μm.

37. The kit of claim 27, wherein one or both of the first and second plates are flexible; and wherein the thickness of the flexible plate times the Young's modulus of the flexible plate is in the range of 60 to 750 GPa-μm; wherein the fourth power of the inter-spacer-distance (ISD) divided by the thickness of the flexible plate (h) and the Young's modulus (E) of the flexible plate, ISD⁴/(hE), is equal to or less than 10⁶ μm³/GPa.

38. The kit of claim 27, wherein one or both of the first and second plates are flexible; wherein the spacer height is selected in the range of 0.5 to 50 μm, the ISD is 100 μm or less, the fourth power of the inter-spacer-distance (ISD) divided by the thickness (h) and the Young's modulus (E) of the flexible plate (ISD⁴/(hE)) is 5×10⁵ μm³/GPa or less; the thickness of the flexible plate times the Young's modulus of the flexible plate is in the range of 60 to 750 GPa-μm.

39. The system of claim 3, wherein one or both of the first and second plates comprises the spacers that regulate the distance between the first plate and the second plate.

40. The system of claim 39, wherein the spacing between the two plates or the height of the spacers is selected between 0.5 μm to 30 μm.

41. The system of claim 39, wherein the spacing between the two plates or the height of the spacers is 10 μm.

42. The system of claim 3, wherein the first and second plates are movable relative to each other.

43. The system of claim 3, wherein the spacing between the two plates or the spacer height is selected to have a stain saturation time of 5 sec, 10 sec, 20 sec, 30 sec, 60 sec, or a range between any two of the values.

44. The system of claim 3, wherein the machine learning algorithm employs CycleGAN.

45. The system of claim 3, wherein the machine learning algorithm employs GAN based pixel-to-pixel transform.

46. The system of claim 3, wherein the machine learning algorithm is trained using a training data set that comprises at least one image of the at least three position markers and the stained sample that is stained in a first set of conditions, and at least one image of the stained sample that is stained in a second set of conditions.

47. The system of claim 3, wherein the machine learning algorithm employs at least four position markers.

48. The system of claim 3, wherein the machine learning algorithm employs the position markers that have a geometry and/or a inter distance between the position markers in x-direction different from that in y-direction which is orthogonal to the x-direction.

49. The system of claim 3, wherein the staining reagent comprise the agent for H&E staining, immunohistochemical staining, immuno-fluorescence staining, in situ hybridization staining, or any combination of thereof.

50. The system of claim 3, wherein the staining reagent is a dry staining reagent coated on the surface of at least one of the plates.

51. The system of claim 3, wherein the system further comprises a transfer liquid between the sample and the second plate; wherein the staining reagent is a dry staining reagent coated on the surface of at least one of the plates, and wherein the transfer liquid transfers the dry staining reagent into the sample.

52. The system of claim 39, wherein the spacers are position markers.

53. The system of claim 39, wherein the inter distance between neighboring spacers or between neighboring position markers is in the range of 50 μm to 120 μm.

54. The system of claim 39, wherein one or both of the first and second plates are flexible; and wherein the thickness of the flexible plate times the Young's modulus of the flexible plate is in the range of 60 to 750 GPa-μm; wherein the fourth power of the inter-spacer-distance (ISD) divided by the thickness of the flexible plate (h) and the Young's modulus (E) of the flexible plate, ISD⁴/(hE), is equal to or less than 10⁶ μm³/GPa.

55. The system of claim 39, wherein one or both of the first and second plates are flexible; wherein the spacer height is selected in the range of 0.5 to 50 μm, the ISD is 100 μm or less, the fourth power of the inter-spacer-distance (ISD) divided by the thickness (h) and the Young's modulus (E) of the flexible plate (ISD⁴/(hE)) is 5×10⁵ μm³/GPa or less; the thickness of the flexible plate times the Young's modulus of the flexible plate is in the range of 60 to 750 GPa-μm.

56. The method of claim 1, wherein the target image is for cytopathology.

57. The method of claim 1, wherein the target image is for pathology.

58. The method of claim 1, wherein the sample is a biopsy sample.

59. The method of claim 1, wherein the staining reagent is a staining liquid that drops on the tissue, one plate, both plate, or any combination thereof.

60. The method of claim 1, wherein the staining reagent is a H&E staining solution and is dropped on the sample or on the plate.

61. The method of claim 1, wherein the target image comprises diagnosing cancer, infectious diseases, or other inflammatory conditions.

62. The method of claim 1, wherein the target image comprises measuring the ratio of the area of a cell to the area of the nucleus of the cell.

63. The method of claim 1, wherein the target image comprises measuring the ratio of the area of a cell to the area of the nucleus of the cell, and wherein the ratio is used to screen a smoker or a non-smoker.

64. The method of claim 1, wherein the sample is a tissue smear.

65. The method of claim 1, wherein the staining reagent comprises permeabilizing agents capable of permeabilizing cells in the tissue sample that contain the target analyte.

66. The method of claim 1, wherein the staining reagent comprises fluorescent/non-fluorescent dye for biological molecule.

67. The method of claim 1, wherein the staining comprises H&E staining.

68. The method of claim 1, wherein the staining comprises immunohistochemical staining.

69. The method of claim 1, wherein the staining comprises immuno-fluorescence staining.

70. The method of claim 1, wherein the staining comprises in situ hybridization staining.

71. The method of claim 1, wherein the staining comprises special staining.

72. The method of claim 1, wherein the staining comprises cell viability stains.

73. The method of claim 1, wherein the staining comprises cell viability stains.

74. The method of claim 1, wherein the sample contains or is suspected of containing a target analyte, and wherein the staining reagent comprises detection agents that specifically label the target analyte in the sample.

75. The method of claim 73, wherein the target analyte comprises a protein, nucleic acid, peptide, amino acid, or cell.

76. The method of claim 73, wherein the target analyte comprises biological molecule.
